(19) United States
(12) Patent Application Publication
(10) Pub. No.: US 2003/0055907 A1
(43) Pub. Date: Mar. 20, 2003

(54) Clientless electronic mail MIME attachment re-delivery system via the web to reduce network bandwidth usage

(76) Inventor: Todd Stiers, Berkeley, CA (US)

Correspondence Address: GRAY, CARY, WARE & FREIDENRICH LLP, 1221 SOUTH MOPAC EXPRESSWAY, SUITE 400, AUSTIN, TX, 78746-6875, US

(21) Appl. No.: 10/245,996

(22) Filed: Sep. 18, 2002

Related U.S. Application Data
(60) Provisional application No. 60/323,019, filed on Sep. 18, 2001.

(51) Int. Cl. G06F 15/16

(52) U.S. Cl. 709/206

(57) ABSTRACT

A method to reduce the network capacity usage of electronic email containing MIME-encoded attachments. A proxy server located between the email client and the source email server separates the MIME parts of the message, removes one or more MIME attachments, then inserts links corresponding to the one or more MIME attachments into the email message. The proxy server transmits the email message to the client using a 7-bit text format. The end user may click on a link corresponding to a MIME attachment to access the attachment. The attachment is transmitted to the client using a non-7-bit format. The proxy server can act as a protocol proxy, retrieving and transmitting messages in real time, or it can retrieve, transform, and cache messages before clients request them.

### BACKGROUND OF INVENTION

1. Technical Field

This invention generally relates to processing of electronic mail messages with Multipurpose Internet Mail Extensions (MIME), and more particularly to removing MIME attachments from electronic mail messages and making the attachments accessible through Web links.

2. Related Art

Internet electronic mail (email) is non-interactive, and most email servers and clients are designed for low-cost, high-bandwidth Internet services. These characteristics mean that email uses resources inefficiently in low-performance, high-cost connection environments, such as wireless networks.

Email gateways require email to be encoded in 7-bit text formats. The first email messages were ASCII text, which required only 7 bits to express the full character set on early mainframe terminals.

With the advent of email attachments and the MIME standard (RFC 1049and RFC-1341), encoding techniques are required to convert 8-bit multimedia formats into 7-bit formats to guarantee backward compatibility with older email gateways and reader clients.

The base 64 encoding scheme is one popular encoding technique for converting 8-bit content to 7-bit clean MIME attachments. This process adds significant overhead, as every 8-bit byte of content is converted into a 7-bit representation plus remainder. Using only 7 bits out of a potential 8 bits per byte increases the overall size of the message.

Unlike email, the more recent HTTP protocol is capable at handling 8-bit, multi-media content. In addition to supporting content encodings like email's base 64 type, compressed encodings, namely gzip and compress, are available in most modern Web-browsing clients.

Email servers and clients treat MIME-compliant email messages as single, large objects. MIME messages include boundary definitions of the multiple parts of the message, and standard tools (e.g., Perl or Java objects) can parse the messages.

### BRIEF SUMMARY OF THE INVENTION

This invention comprises systems and methods for removing electronic mail MIME attachments from an email message and replacing them with Web (HTML) links, thereby reducing the network capacity usage of email containing MIME-encoded attachments. The end user receives the non-attachment portions of an email message with a standard email client and can select the Web links to download the attachments via the Web.

By removing the attachments from email messages, this invention may reduce the bandwidth use between the email gateway and the user in various ways. For example, it may enable faster download of the non-attachment portions of a message. User preferences can determine which portions of a message the proxy server treats as attachments. It may also enable faster download of attached portions of the email message, accomplished both by avoiding base 64 encoding and by applying Web-compliant compression. Further, it may eliminate the need to transmit some data. Because users can control when or if they wish to download attachments, not all attachments may need to be transmitted.

This invention can leverage common clients, standards and protocols for email and the Web, using server-side intelligence to deliver content to the user over poor-performance network environments. It is particularly applicable to the wireless environment where network capacity is expensive and speeds are slow.

One embodiment of the invention comprises a method for increasing the speed and minimizing the bandwidth required for delivering email messages containing MIME attachments to a client. The method of this embodiment comprises receiving an email message having one or more MIME attachments, removing the MIME attachments from the email message, inserting one or more links corresponding to the one or more MIME attachments into the email message, and transmitting the email message containing the one or more links to the client using a 7-bit text format. The client may then select the links to access the attachments, which are delivered to the client using an 8-bit format.

Another embodiment of the invention comprises a system in which a proxy server is located between an email server and a client. The proxy server is configured to receive an email message having one or more MIME attachments from the email server, and to remove the one or more attachments from the email message. The proxy server inserts links corresponding to the one or more attachments into the email message and then transmits the modified email message to the client in a 7-bit format. In response to the client selecting a link, the corresponding attachment is delivered to the client in an 8-bit format.

Another embodiment of the invention comprises software configured to implement the methods described herein. (“Software” is used herein to refer to software, firmware, and other manners of programming instructions for a computer or other data processor.) The software may be embodied in any medium readable by such a computer or data processor, including floppy disks, magnetic tapes, CD-ROMs, DVD-ROMs, RAM, ROM, and the like. Likewise, a computer or data processor which is configured to execute such software applications, or which is otherwise programmed to perform the methods disclosed herein is intended to be covered by the present application.

Various other embodiments are also possible.

### BRIEF DESCRIPTION OF THE DRAWINGS

Other objects and advantages of the invention may become apparent upon reading the following detailed description and upon reference to the accompanying drawings.

FIG. 1 shows the system architecture for an embodiment in which a proxy server collects and caches email messages independently of the client's requests. The proxy server transforms and delivers attachments.

FIG. 2 is a flowchart outlining in detail the steps that the proxy server and client execute in FIG. 1.

FIG. 3 shows the system architecture for an embodiment in which a proxy server scans and reformats email nearly in real time. The proxy server transforms and delivers attachments.

FIG. 4. is a flowchart outlining in detail the steps that the proxy server and client execute in FIG. 3.

FIG. 5 shows the system architecture for an embodiment in which an email proxy server scans and reformats email nearly in real time. A separate, stand-alone Web server transforms and delivers attachments.

FIG. 6 is a flowchart outlining in detail the steps that the email proxy server, client, and separate Web server take in FIG. 5.

While the invention is subject to various modifications and alternative forms, specific embodiments thereof are shown by way of example in the drawings and the accompanying detailed description. It should be understood, however, that the drawings and detailed description are not intended to limit the invention to the particular embodiment which is described. This disclosure is instead intended to cover all modifications, equivalents and alternatives falling within the scope of the present invention as defined by the appended claims.

### DETAILED DESCRIPTION OF THE INVENTION

Preferred embodiments of the invention are described below. It should be noted that these and any other embodiments described below are exemplary and are intended to be illustrative of the invention rather than limiting.

This invention comprises systems and methods for removing electronic mail MIME attachments from an email message and replacing the attachments with links to the attachments. The end user receives the non-attachment portions of an email message with a standard email client and can select the links to download the attachments (for example, using an ordinary browser to access the attachments via the Web). The non-attachment portions of the message can be downloaded faster because they do not include the attachments, and the attachments can be downloaded faster because they are converted from the 7-bit MIME format to their original 8-bit format.

This functionality may be implemented in a proxy server positioned between the source email server and the email client. The proxy server is configured to remove the MIME attachments from email messages, decode the attachments, and insert links to the attachments in the email messages.

When the proxy server removes attachments from email messages, the attachments are decoded from the standard base 64, 7-bit clean encoding to the original, 8-bit format. This significantly reduces the attachment size, since bytes encoding only 7-bits each are transcoded into fewer bytes encoding 8 bits each.

The Web links that the proxy server adds to the message make the attachments accessible via a Web server and client, and the Web server's built-in decompression algorithms can compress the attachments to sizes well below the original, non-compressed size. The Web server that transforms and delivers the attachments can be either the email proxy server itself or a separate, stand-alone Web server. The proxy server uses the HTTP protocol to send MIME attachments to client devices, so it can apply all Web-compliant transformations to them. The advantage of using a separate Web server is that an end user can retrieve attachments through a non-proxied channel.

The proxy server combines, and potentially encrypts, several pieces of information to generate a passkey which can be used to uniquely identify and retrieve attachments. The information combined is: the end user's account name, a unique identifier for the message, and an indicator of which attachment within the message. When the proxy server is configured to allow users to access multiple email servers at the same time, the key also must incorporate the source email server information. To generate these keys, the proxy server must request a unique identifier for each message from the source email server.

In a deployment that uses a separate Web server for attachment traffic, to avoid the need to look up the user's account, mailserver and password when retrieving attachments, the links themselves must include that information. Alternatively, the separate Web server must store that information, potentially using some sort of user profile storage mechanism.

To ensure that the intended recipient is the only one who can retrieve an attachment, the proxy server should encrypt the key that identifies the attachment. To create standards compliant Web links which can be used to retrieve attachments, the proxy server should further Web-encode the keys after they have been encrypted. The proxy server then replaces the attachments within a message with web links, also known as URLs (uniform resource locators), which include the Web-encoded, encrypted keys

In one embodiment of the invention, the end user's email messages and attachments are pre-fetched and cached by the proxy server in a dedicated email spool and Web attachment area, ready for the user to retrieve. The proxy server loads the spools offline periodically at some configurable interval. The advantage of this embodiment is that removing attachments, generating Web links, and compressing attachments can be performed offline or during idle times. This embodiment may, however, use large amounts of disk space on the proxy server and may raise privacy concerns relating to email content re-distribution.

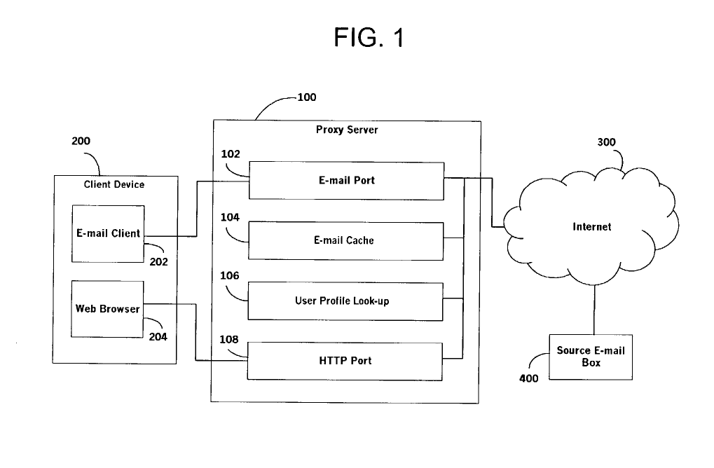

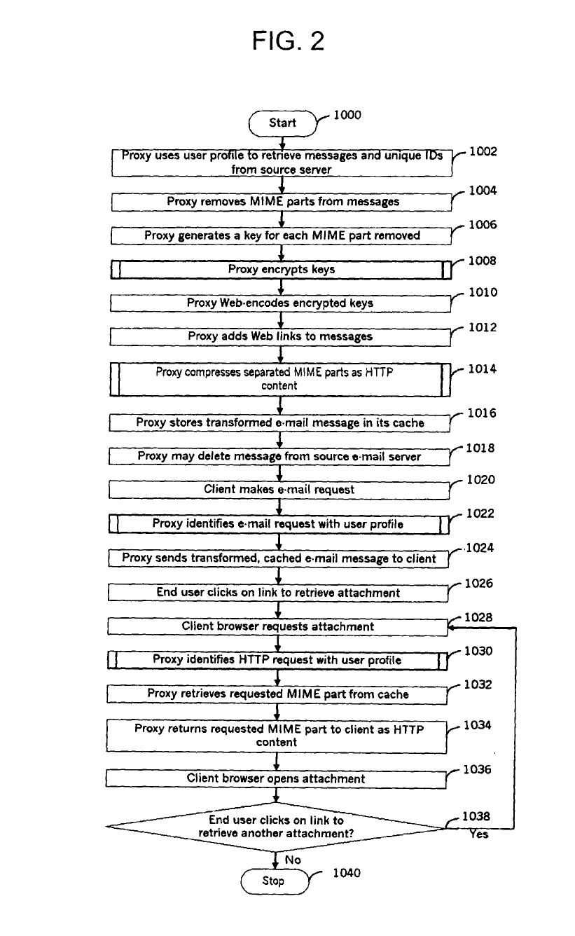

FIG. 1 illustrates a system architecture in accordance with this embodiment, and FIG. 2 is a flowchart showing the steps that the proxy server and client device may execute in this embodiment. Reference numbers for both the architecture diagram of FIG. 1 and the flowchart of FIG. 2 are incorporated into the discussion below. The reference numbers for FIG. 2 are enclosed in parentheses to make them more easily distinguishable from the reference numbers for FIG. 1.

The proxy server 100 collects and stores email messages independently of the client's requests. User profiles 106 stored on the proxy server 100 provide information on end users' source email servers 400, accounts and passwords. The method that the proxy server 100 uses to store and look up user profiles 106 depends on the deployment. The proxy server 100 stores end users' email messages in its cache 104.

The proxy server 100 uses the client's user profile information 106 to issue a retrieve request over the Internet 300 to the end user's source email server 400. When it issues the retrieve request, the proxy server 100 also issues a request for the unique identifier for any message it retrieves. The proxy server 100 retrieves full email messages (and their unique identifiers) from the source email server 400 (1002), leaving the original messages on the source email server 400. The proxy server 100 can retrieve email from multiple accounts for the same user.

The proxy server 100 removes the MIME attachments from the email message (1004). For each attachment removed, the proxy server 100 generates a key (1006). The key combines the following information: the user-identifier, the message-identifier, and the attachment number. When the proxy server 100 is configured to allow users to access multiple email servers at the same time, the key should also include the source email server 400 information.

If the security of the attachments is a concern, the proxy server 100 should encrypt the keys to the attachments (1008). The proxy server 100 can Web-encode the keys (1010), then add the Web-encoded keys to the message as Web link URLs (1012), which connect to the attachments removed from the message. The proxy server 100 may compress separated parts of the message as necessary (1014).

The proxy server 100 stores the transformed email message in its cache 104 (1016), then may then delete the email message from the source email server 400 (1018).

The end user's email application 202 makes an email request (1020). The proxy server's email port 102 receives the request. The proxy server 100 identifies the request with a user profile 106 (1022), retrieves the end user's email from its cache 104, then sends the transformed, cached email message to the client 200 (1024).

When the end user clicks on a link to retrieve an attachment (1026), a browser 204 window opens automatically and issues an HTTP request for the attachment (1028). (The success of this step depends on the configuration of the client device.) The proxy server's HTTP port 108 receives the request. The proxy server 100 identifies the HTTP request with a user profile 106 (1030), retrieves a copy of the requested MIME part from its cache 104 (1032), then returns the requested MIME part to the client 200 as HTTP content (1034). The client device's Web browser 204 opens the attachment (1036). If the browser 204 does not recognize the content type of the attachment, it opens a dialog box allowing the user to save the file to disk. (The success of this step depends on the configuration of the client device.) The end user may retrieve another attachment by clicking on another link (1038).

A second embodiment of this invention is to use a protocol proxy (for example, POP or IMAP) to make client requests to the source email server and return server responses to the client. The advantage of this system is that the proxy server scans and reformats email messages in near real time, using an off-site email repository (the source email server). The only information stored on (or network accessible to) the proxy is the user profile, which is only required in some embodiments. No part of an email message is stored on the proxy server, so the system does not require the implementation overhead or raise the privacy issues of queuing mail and attachments in third party spools. The main concern that this embodiment raises is email box synchronization, since, if an email message is deleted from the source email server, the Web links to the message's attachments will not work.

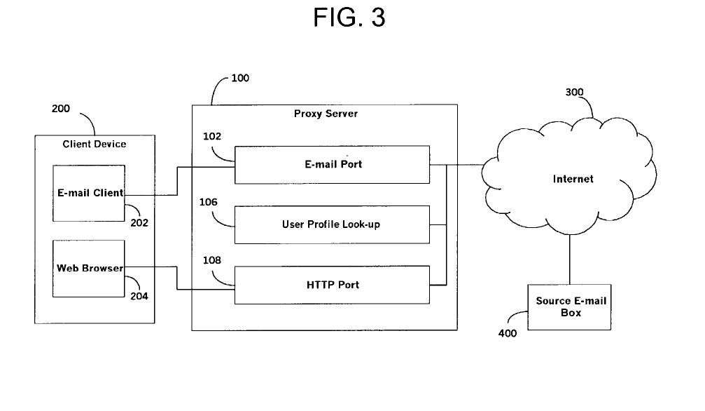

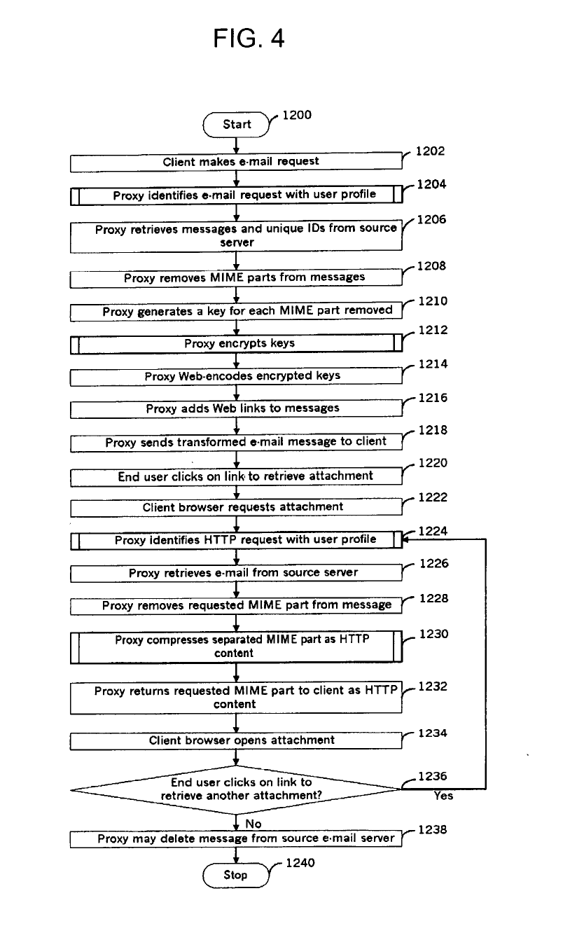

FIG. 3 illustrates the system architecture of this second embodiment, and FIG. 4 is a flowchart showing the steps that the proxy server and client device execute. Again, the reference numbers for the flow diagram of the method are enclosed in parentheses, while the reference numbers for the architecture diagram are not.

Before making a request to a source email server 400, the proxy server 100 must receive a request from a client 200. The proxy server 100 may alter this request before sending it over the Internet 300 to the source email server 400.

The end user's email application 202 makes an email request (1202). The proxy server's email port 102 receives the request, and the proxy server 100 identifies the request, potentially using a user profile 106 (1204). The proxy server 100 issues a retrieve request on behalf of the client 200 to the source email server 400. When it issues the retrieve request, the proxy server 100 also issues a request for the unique identifier for any message it retrieves. The proxy server 100 retrieves the end user's email messages (and their unique identifiers) from the source email server 400 (1206), including a full copy of any MIME messages, leaving the original messages on the email server 400.

The proxy server 100 removes attachments from the email message (1208). For each attachment removed, the proxy server 100 generates a key. (1210). The key combines the following information: the user-identifier, the message-identifier, and the attachment number. When the proxy server is configured to allow users to access multiple email servers at the same time, the key also must include the source email server information.

If the security of the attachments is a concern, the proxy server 100 should encrypt the keys to the attachments (1212). The proxy server 100 Web-encodes the encrypted keys (1214), then adds the Web-encoded keys to the message as Web link URLs (1216), which connect to the attachments removed from the message.

The proxy server 100 sends the transformed email message to the email client 202 (1218).

When the end user clicks on a link to retrieve an attachment (1220), a browser 204 window opens automatically and issues an HTTP request for the attachment (1222). (The success of this step depends on the configuration of the client device.) The proxy server's HTTP port 108 receives the request. The proxy server 100 identifies the HTTP request with a user profile 106 (1224), then retrieves a copy of the full email message from the source email server 400 (1226), leaving the original message on the email server 400. The proxy server 100 separates the MIME part requested (1228), compresses it as necessary (1230), then returns the requested MIME part the client 200 as HTTP content (1232). The client device's Web browser 204 opens the attachment (1234). If the browser 204 does not recognize the content type of the attachment, it opens a dialog box allowing the user to save the file to disk. (The success of this step depends on the configuration of the client device.)

The end user may retrieve another attachment by clicking on another link (1236).

The proxy server 100 may delete an email message from a source email server 400 (1238).

A third embodiment of this invention is to use a proxy server for email traffic only, and to use a separate, stand-alone Web server to handle end user requests for attachments and the source server's responses. The email proxy generates attachment links containing enough information to allow the separate Web server to identify and retrieve attachments. (In an alternative embodiment, the separate Web server could store the same user profiles as the email proxy server.) The email proxy server scans and reformats email messages in near real time, using an off-site email repository (the source email server). In addition to offering the advantages of the second embodiment, this third embodiment allows end users to access their attachments through a non-proxied channel. The concerns that this embodiment raises are the same as those of the second embodiment.

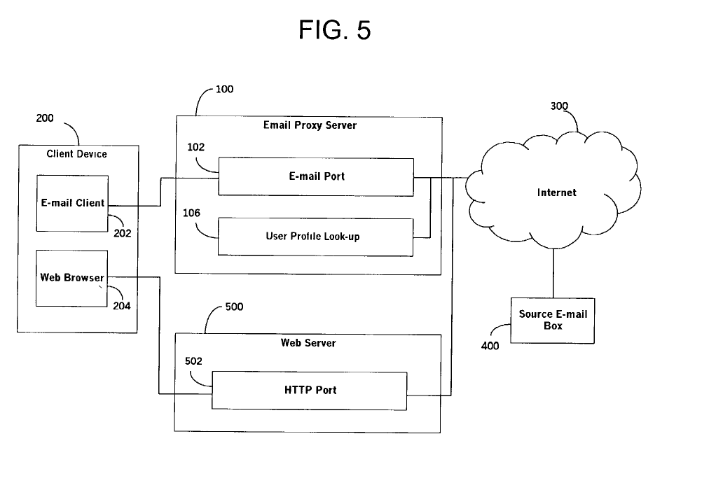

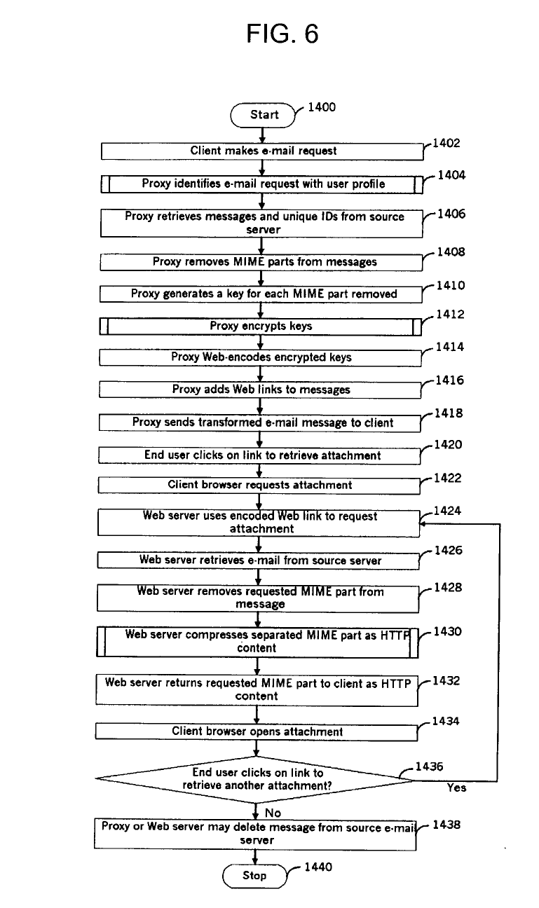

FIG. 5 illustrates the system architecture of this third embodiment, and FIG. 6 is a flowchart showing the steps that the email proxy server, client device, and the separate Web server execute.

Before making a request to a source email server 400, the email proxy server 100 must receive a request from a client 200. The email proxy server 100 may alter this request before sending it over the Internet 300 to the source email server 400.

The end user's email application 202 makes an email request (1402). The proxy server's email port 102 receives the request, and the proxy server 100 identifies the request with a user profile 106 (1404). The proxy server 100 issues a retrieve request on behalf of the client 200 to the source email server 400. When it issues the retrieve request, the proxy server 100 also issues a request for the unique identifier for any message it retrieves. The proxy server 100 retrieves the end user's email messages (and their unique identifiers) from the source email server 400 (1406), including a full copy of any MIME messages, leaving the original messages on the email server 400.

The proxy server 100 removes parts of the email message (1408), For each attachment removed, the proxy server 100 generates a key. (1410). The key combines the following information: the user-identifier, the message-identifier, and the attachment number. When the proxy server 100 is configured to allow users to access multiple email servers at the same time, the key also must include the source email server 400 information. In cases where the attachment is to be retrieved from a stand-alone server 500 that does not have a user profile containing the user's mail server or mail account password, then that information also must be combined into the key. Any reversible method of combination can be used, for example, concatenation.

If the security of the attachments is a concern, the proxy server 100 should encrypt the keys to the attachments (1412), Web-encodes the encrypted keys (1414), then adds the Web-encoded keys to the message as Web link URLs (1416), which connect to the parts removed from the message.

The proxy server 100 sends the transformed email message to the email client 202 (1418).

When the end user clicks on a link to retrieve an attachment (1420), a browser 204 window opens automatically and issues an HTTP request for the attachment (1422). (The success of this step depends on the configuration of the client device.) The separate Web server's HTTP port 502 receives the request. The separate Web server 500 uses the key in the encoded Web link to request the attachment (1424), then retrieves a copy of the full email message from the source email server 400 (1426), leaving the original message on the email server 400. The separate Web server 500 separates the MIME part requested (1428), compresses it as necessary (1430), then returns the requested MIME part the client 200 as HTTP content (1432). The client device's Web browser 204 opens the attachment (1434). If the browser 204 does not recognize the content type of the attachment, it opens a dialog box allowing the user to save the file to disk. (The success of this step depends on the configuration of the client device.)

The end user may retrieve another attachment by clicking on another link (1436).

The proxy server 100 or the separate Web server 500 may delete an email message from a source email server 400 (1438).

The benefits and advantages which may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms ‘comprises,’ ‘comprising,’ or any other variations thereof, are intended to be interpreted as non-exclusively including the elements or limitations which follow those terms. Accordingly, a process, method, article, or apparatus that comprises a list of elements does not include only those elements but may include other elements not expressly listed or inherent to the claimed process, method, article, or apparatus.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

What is claimed is:

1. A method comprising:
receiving an email message having one or more MIME attachments;
removing the MIME attachments from the email message;
inserting one or more links corresponding to the one or more MIME attachments into the email message; and
transmitting the email message containing the one or more links to a client.

2. The method of claim 1, further comprising transmitting one of the one or more attachments to the client in response to the client selecting the corresponding one of the one or more links.

3. The method of claim 2, further comprising converting the one of the one or more attachments to a non-7-bit-text format prior to transmitting the one of the one or more attachments to the client.

4. The method of claim 2, further comprising storing the attachments in a cache in a proxy server and retrieving the attachments from the cache prior to transmitting the one or more attachments to the client.

5. The method of claim 2, further comprising, in response to the client selecting one of the one or more links, retrieving the email message from an email source, removing from the email message the one of the one or more attachments corresponding to the selected link, and converting the one of the one or more attachments corresponding to the selected link to a non-7-bit-text format prior to transmitting the one of the one or more attachments to the client.

6. The method of claim 5, wherein the email message containing the one or more links is transmitted to the client by a proxy server and the one of the one or more attachments is transmitted to the client by a Web server which is separate from the proxy server.

7. The method of claim 2, further comprising retrieving a user profile corresponding to the client and retrieving the one of the one or more attachments based upon the user profile.

8. The method of claim 1, The method of claim 1, wherein the email message containing the one or more links is transmitted to the client using a 7-bit text format.

9. The method of claim 1, further comprising generating a key for each of the attachments removed from the email message and incorporating each key in the link to the corresponding attachment.

10. The method of claim 9, wherein the key includes a user identifier, a message identifier, and an attachment identifier.

11. The method of claim 10, wherein the key also includes an email source identifier.

12. The method of claim 9, further comprising encrypting the keys.

13. The method of claim 1, wherein the links comprise Web URLs.

14. A system comprising:
a proxy server,
wherein the proxy server is configured to receive an email message from a mail server, wherein the email message has one or more MIME attachments, and
wherein the proxy server is configured to remove the one or more attachments from the email message and to insert one or more links corresponding to the one or more attachments into the email message, and to transmit the modified email message to a client.

15. The system of claim 14, wherein the proxy server is configured to provide one of the one or more attachments in response to the client selecting a corresponding one of the one or more links.

16. The system of claim 15, wherein, in response to the client selecting the one of the one or more links, the proxy server is configured to retrieve the original email message from a mail server, extract the corresponding one of the one or more attachments from the original email message, and transmit the extracted attachment to the client.

17. The system of claim 16, further comprising a Web server which is separate from the proxy server, wherein the proxy server is configured to transmit the email message containing the one or more links to the client and the Web server is configured to transmit the one of the one or more attachments to the client.

18. The system of claim 15, further comprising a cache, wherein the proxy server is configured to store the attachments in the cache and wherein, in response to the client selecting the one of the one or more links, the proxy server is configured to retrieve the corresponding one of the one or more attachments from the cache, and transmit the retrieved attachment to the client.

19. The system of claim 15, wherein the proxy server is configured to transmit the extracted attachment is over a non-seven-bit protocol.

20. The system of claim 15, further comprising a memory configured to store one or more user profiles, wherein the proxy server is configured to retrieve a user profile corresponding to the client and to retrieve the one of the one or more attachments based upon the retrieved user profile.

21. The system of claim 14, wherein the proxy server is configured to transmit the email message containing the one or more links to the client in a 7-bit text format.

22. The system of claim 14, wherein the proxy server is configured to generate a key for each of the attachments removed from the email message and to incorporate each key in the link to the corresponding attachment.

23. The system of claim 22, wherein each key includes a user identifier, a message identifier, and an attachment identifier.

24. The system of claim 23, wherein each key further includes an email source identifier.

25. The system of claim 22, wherein the proxy server is configured to encrypt each key.

26. The system of claim 14, wherein the links comprise Web URLs.
